(19) United States
(12) Patent Application Publication
(10) Pub. No.: US 2004/0237487 A1
(43) Pub. Date: Dec. 2, 2004

(54) Vertical cyclone separator

(76) Inventors: Andreas Ekker, Amsterdam (NL); Cornelis Josephus Maria De Kort, Amsterdam (NL)

Correspondence Address: Richard F Lemuth, Shell Oil Company, Intellectual Property, P O Box 2463, Houston, TX, 77252-2463, US

(21) Appl. No.: 10/416,081

(22) PCT Filed: Nov. 7, 2001
(86) PCT No.: PCT/EP01/13032

(30) Foreign Application Priority Data
Nov. 7, 2000 (EP) 00203901.4

(51) Int. Cl. B01D 45/12

(52) U.S. Cl. 55/459.1

(57) ABSTRACT

Vertical cyclone vessel (1) having a tubular housing (2) comprising of a tubular wall section (3) provided with a tangentially arranged inlet (3) for receiving a suspension of gas and solids and an elevated cover (5) which closes the upper end of the tubular wall section, wherein a gas outlet conduit (6) significantly protrudes from above and along the axis (7) into the tubular housing to at most the horizontal position of the centre of the tangentially arranged inlet.

The invention is directed to an improved cyclone separator. The invention is also directed to the use of such a cyclone in a fluid catalytic cracking process.

Such a separator is described in WO-A-0050538. According to this publication a cyclone separator is disclosed which has an improved separation efficiency as compared to the conventional cyclone separators as exemplified in FIG. 17-36 of Perry's Chemical Engineers' handbook, McGraw Hill, 7 th ed., 1997.

The present invention aims at providing a separator having an even more improved separation efficiency as the cyclone separators disclosed in this PCT publication.

This object is achieved with the following cyclone separator. Vertical cyclone vessel having a tubular housing comprising of a tubular wall section provided with a tangentially arranged inlet for receiving a suspension of gas and solids and an elevated cover which closes the upper end of the tubular wall section, wherein a gas outlet conduit significantly protrudes from above and along the axis into the tubular housing to at most the horizontal position of the centre of the tangentially arranged inlet.

Applicants have found that the cyclone separator of the invention achieves an improved separation efficiency as compared to the cyclone separator of the state of the art, especially when the feed contains relatively high levels of solids.

The invention shall be described in more detail below, including some preferred embodiments.

The cover of the cyclone is elevated with respect to the tangentially arranged inlet for receiving a suspension of solids and gas. With elevated is here meant that the distance between the cover and the centre of the tangentially arranged inlet is greater than generally applied. Typical cyclones as illustrated in the prior art have a cover which is positioned just above the tangentially arranged inlet. Preferably the elevated cover is arranged at a vertical distance (d1) above the centre of the tangentially arranged inlet opening and wherein the ratio of this distance (d1) and the diameter of the tubular housing (d2) is between 0.2 and 3 and more preferably between 0.5 and 2 and most preferably between 0.5 and 1.5.

The gas outlet conduit protrudes significantly the tubular housing of the cyclone from above. With significantly protruding is meant that the protrusion distance (d3) as measured from the elevated cover into the tubular housing is at least 0.4 times greater than the diameter (d4) of the gas outlet conduit. Preferably greater than 0.5 the diameter (d4) of the gas outlet conduit. More preferably the ratio of distance (d3) and the distance (d1) between the elevated cover and the centre of the tangentially arranged inlet opening is between 0.1 and 0.6, more preferably between 0.4 and 0.6.

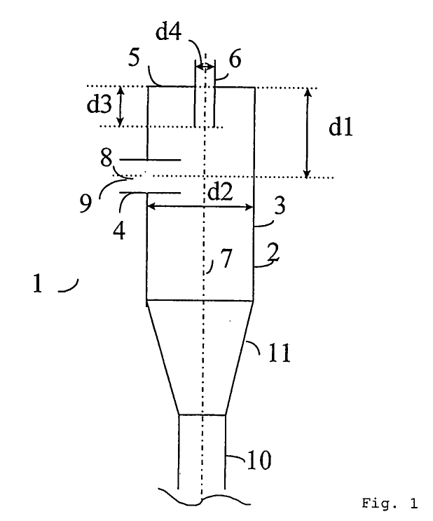

FIG. 1 illustrates a cyclone according to the present invention. FIG. 1 shows a vertical cyclone vessel (1) having a tubular housing (2) comprising of a tubular wall section (3) provided with a tangentially arranged inlet (4) for receiving a suspension of gas and solids and an elevated cover (5) which closes the upper end of the tubular wall section (3), wherein a gas outlet conduit (6) significantly protrudes from above and along the axis (7) into the tubular housing (2) to at most the horizontal position (8) of the centre (9) of the tangentially arranged inlet (4). The illustrated vertical cyclone according (1) is also provided with an optional dipleg (10) at the lower end of the tubular wall section (3), which dipleg (10) (partly shown) is fluidly connected to the tubular wall section by means of a frustoconical wall section (11). The figure also illustrates the distances d1, d2, d3 and d4 as used above.

The cyclone according to the invention can advantageously be used as a primary cyclone in combination with a secondary cyclone wherein the gas outlet conduit of the primary cyclone is fluidly connected to a tangentially arranged inlet of a secondary cyclone. The secondary cyclone can be a state of the art cyclone as for example disclosed in FIG. 17-36 of Perry's Chemical Engineers' handbook, McGraw Hill, 7 th ed., 1997.

The cyclone separator is used for separating solid particles from a suspension of particles and gas. The cyclone according to the invention can find use in any process in which solid particles are to be separated from a suspension of said solid particles and a gas. Examples of such process are the MTBE-fluidized bed dehydrogenation process, the acrylonitrile process and the fluid catalytic cracking (FCC) process. Examples of such a fluid catalytic cracking process are described in Catalytic Cracking of Heavy Petroleum Fractions, Daniel DeCroocq, Institut Francais du Petrole, 1984 (ISBN 2-7108-455-7), pages 100-114. Preferably the apparatus is used in an FCC process wherein a gas solids suspension if fed to the primary cyclone having a solids content of between 1 and 15 kg/m³. Preferably the cyclone according to the present invention is used as the primary cyclone in the preferred embodiments as disclosed in WO-A-0050538 and especially those illustrated in FIGS. 1-5 of said publication.

The invention is also directed to a fluidized catalytic cracking reactor vessel wherein the downstream end of a reactor riser is in fluid communication with the tangentially arranged inlet of a cyclone according to the present invention, the vessel further comprising at its lower end a stripping zone provided with means to supply a stripping medium to a dense fluidized bed of separated catalyst particles, means to discharge stripped catalyst particles from the vessel and means to discharge the hydrocarbon and stripping medium vapours from the vessel.

The invention shall be illustrated with the following example.

### EXAMPLE

To a cyclone separator having the design as in FIG. 1 a gas-solids suspension was fed having a dustload of 8 kg solids/kg gas. The average particle size of the solids was 50 micron. The inlet velocity of the suspension was 20 m/s. The diameter (d2) of the tubular housing was 0.300 m and the distance (d1) between the centre of the inlet and the elevated cover was 0.290 m, such that the ratio d1/d2 was 0.97. The gas outlet conduit had an internal diameter (d4) of 0.108 m. The remaining dimensions of the tubular part of the cyclone, the dipleg and the connecting part are of a conventional size. The protrusion (d3) of the gas outlet was varied and the fraction solids which were not separated in the cyclone (i.e. solids fraction in overflow) was measured at the various values for d3. The results are presented in the below Table.

TABLE

| | | Solids fraction in | Pressure drop |
|---|---|---|---|
| | d3/d1 | Overflow (wt %) | (Pa) |
| 1 | 0 | 0.3 | 2002 |
| 2 | 0.19 | 0.1 | 2037 |
| 3 | 0.65 | 0.2 | 2110 |

1. A vertical cyclone vessel having a tubular housing comprising of a tubular wall section provided with a tangentially arranged inlet for receiving a suspension of gas and solids and a cover which closes the upper end of the tubular wall section, wherein a gas outlet conduit protrudes from above and along the axis into the tubular housing to at most the horizontal position of the center of the tangentially arranged inlet, wherein the cover is arranged at a vertical distance (d1) above the center of the tangentially arranged inlet opening and wherein the ratio of this distance (d1) and the diameter of the tubular housing (d2) is between 0.5 and 2 and wherein the gas outlet conduit protrudes at least distance (d3) as measured from the cover into the tubular housing and wherein the ratio of this distance (d3) and the distance (d1) between the elevated cover and the center of the tangentially arranged inlet opening is between 0.1 and 0.6.

2. The vertical cyclone according to claim 1, wherein the ratio of the distance (d1) and the diameter of the tubular housing (d2) is between 0.5 and 1.5.

3. The vertical cyclone according to claim 2, wherein the gas outlet conduit protrudes at least distance (d3) as measured from the elevated cover into the tubular housing and wherein the ratio of this distance (d3) and the diameter (d4) of the gas outlet conduit is at least 0.4.

4. The vertical cyclone claim 3, wherein a dipleg is present at the lower end of the tubular wall section of the primary cyclone, which dipleg is fluidly connected to the tubular wall section by means of a frustoconical wall section.

5. A separation apparatus comprising a cyclone separator according to any one of claims 1 2, 3 or 4 as primary cyclone wherein the gas outlet conduit is fluidly connected to a tangentially arranged inlet of a secondary cyclone for receiving a suspension of gas and solids.

6. A fluidized catalytic cracking reactor vessel wherein the downstream end of a reactor riser is in fluid communication with the tangentially arranged inlet of a cyclone according to any one of claims 1, 2, 3 or 4 the vessel further comprising at its lower end a stripping zone provided with means to supply a stripping medium to a dense fluidized bed of separated catalyst particles, means to discharge stripped catalyst particles from the vessel and means to discharge the hydrocarbon and stripping medium vapours from the vessel.

7. The use of a cyclone according to claims 1-4 to separate solid particles from a suspension of particles and gas.

8. The use according to claim 7, wherein the solids content of the suspension is between 1 and 15 kg/m³.
